(19) United States
(12) Patent Application Publication
(10) Pub. No.: US 2005/0219394 A1
(43) Pub. Date: Oct. 6, 2005

(54) Digital camera capable of brightness and contrast control

(76) Inventors: Sterling Du, Palo Alto, CA (US); Vlad Mihail Popescu-Stanesti, San Jose, CA (US)

Correspondence Address: WAGNER, MURABITO & HAO, LLP, TWO NORTH MARKET STREET, THIRD FLOOR, SAN JOSE, CA, 95113, US

(21) Appl. No.: 10/819,369

(22) Filed: Apr. 6, 2004

(51) Int. Cl. H04N 5/222

(52) U.S. Cl. 348/333.12

(57) ABSTRACT

A method according to one embodiment may include generating a signal indicative of ambient light in the vicinity of an LCD panel comprised in a digital camera. The method may also include controlling at least one of a brightness and contrast of the LCD panel based at least in part on the signal indicative of ambient light in the vicinity of an LCD panel. Of course; many alternatives, variations, and modifications are possible without departing from this embodiment.

### FIELD

The present disclosure relates to a digital camera capable of brightness and contrast control.

### BACKGROUND

The handheld consumer devices are mainly powered by the battery. The power consumption of the system will affect the battery life. In the DSC case, the power consumption will limit how many pictures can be taken by that camera; this is one of the key parameters for the digital camera design. There are many power management techniques used to reduce the total power consumption of the digital camera. For example, improve the efficiency of the DC/DC converter or shut down power for the circuits which is not needed. The LCD panel on the digital camera is almost always turned on when the digital camera is ON. For example, it is used as the view finder when the user needs to take picture. It is also required when the user reviews pictures taken with the digital camera. At the same time the LCD panel is consuming about 15% of the total power consumption. A conventional digital camera does not include a mechanism to reduce power consumption by adjusting power to the LCD panel based on ambient light conditions.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment;

FIG. 2 is a diagram illustrating another system embodiment; and

FIG. 3 is a diagram illustrating exemplary operational characteristics according to one embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

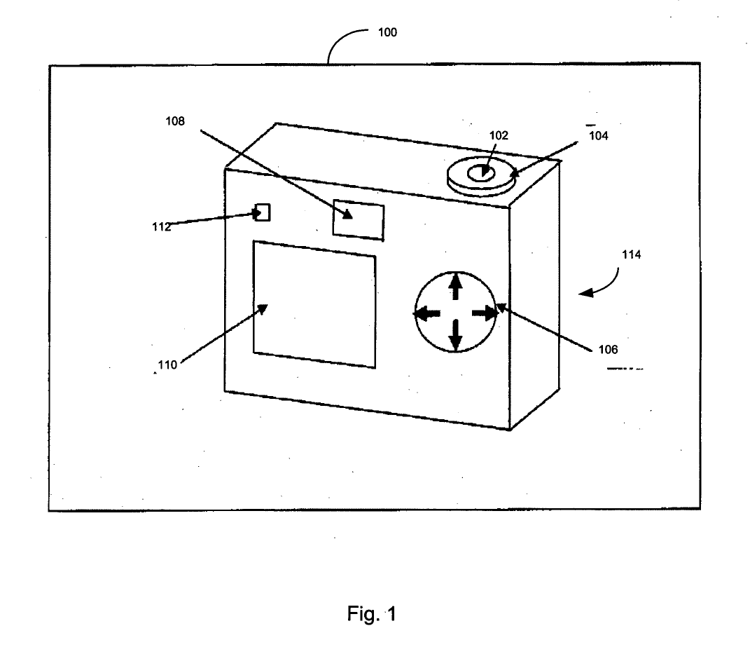

FIG. 1 illustrates a system embodiment 100 of the claimed subject matter. The system 100 may generally include a digital camera 114. The digital camera 114 may comprise a still image camera or a digital video camera. The digital camera 114, as provided in this embodiment, may include a power button 102, an operating mode selection button 104, a user interface control button 106, an optical viewfinder 108 and an LCD panel 110. In this embodiment, a light sensor 112 may be included. The light sensor may be positioned at any location on the digital camera, and in this embodiment, the light sensor 112 may be positioned in proximity to the LCD panel 110. The light sensor may be capable of generating a signal indicative of ambient light conditions. Such a signal may be used by circuitry comprised in the digital camera to adjust the brightness of the LCD panel 110, as will be described in greater detail herein.

It should be understood at the outset that certain components of the digital camera 114 set forth above may comprise conventional, custom, and/or proprietary components. For example, power button 102 may represent a conventional switch which may be provided on a digital camera. Likewise, operating mode selection button 104 and/or user interface control button 106 and/or optical viewfinder 108 and/or LCD panel 110 may represent conventional configurations. Alternatively, in other embodiments any or all of these components may be substituted for currently available and/or after-developed equivalent structures, and/or equivalent functional objects (such as may be implemented in firmware) without departing from the present disclosure. Further, it is to be understood that the present disclosure is of broad scope and it is fully contemplated herein that such equivalents may be used in any embodiment described herein.

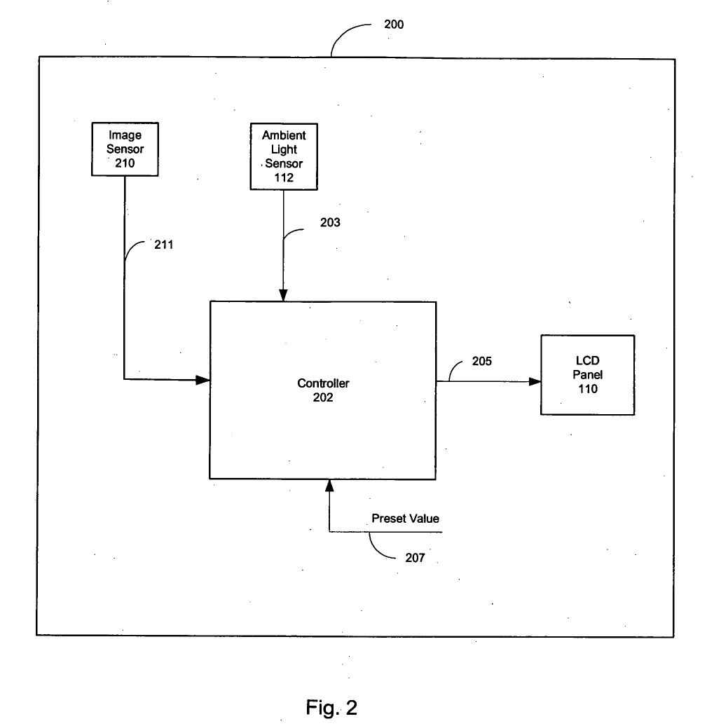

FIG. 2 depicts another system embodiment 200 of the claimed subject matter. This embodiment may comprise digital camera that comprises controller circuitry 202 (hereinafter “controller”) that may be capable of performing all or part of operating task associated with the digital camera. As used herein, “circuitry” may comprise, for example, singly or in any combination, hardwired circuitry, programmable circuitry, state machine circuitry, and/or firmware that stores instructions executed by programmable circuitry. Controller 202 may comprise, for example, an application specific integrated circuit (ASIC), a microprocessor integrated circuit and/or a digital signal processing unit integrated circuit. As used in any embodiment herein, an “integrated circuit” means a semiconductor device and/or microelectronic device, such as, for example, a semiconductor integrated circuit chip. Of course, digital camera 114 may also comprise memory (not shown) which may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively, memory may comprise other and/or later-developed types of computer-readable memory. Machine-readable firmware program instructions may be stored in memory. As described below, these instructions may be accessed and executed by controller 202, and these instructions may result in controller 202 performing the operations described herein as being performed by controller 202.

In this embodiment, controller 202 may be capable of generating one or more signals to adjust the brightness of the LCD panel 110, in a manner described herein. Ambient light sensor 112 may be capable of generating signal 203 indicative and/or proportional to ambient light conditions. Such ambient light conditions may be ambient light conditions in the vicinity of the LCD panel (such as alluded to above with reference to FIG. 1), or may be general ambient light conditions of the operating environment of a digital camera 114. Controller 202 may be capable of receiving signal 203 and generating a control signal 205. Control signal 205 may be capable of adjusting the brightness of the LCD panel 110. “Vicinity” as used in any embodiment herein shall be construed broadly to mean any special relationships between components described herein as being in the “vicinity” of one another. Thus, for example, light sensor 112 may be placed anywhere on the digital camera (for example, anywhere on the housing of the digital camera as depicted in FIG. 1) and is deemed to be in the vicinity of the LCD panel 110.

LCD panel 110 may comprise, for example, a white light emitting diode (WLED) that may be capable of lighting the LCD panel 110. Alternatively, the LCD panel may comprise a fluorescent lighting system and/or other light source to light the panel. In this embodiment, control signal 205 may be capable of controlling the amount of light produced by the LCD panel. Control signal 205 may be capable of adjusting the amount of power delivered to the light. For example, control signal 205 may supply a controllable current to WLED that lights the LCD panel. Alternatively, camera 114 may comprise DC/DC converter circuitry capable of generating a DC signal to the light, and control signal may comprise a pulse width modulated (PWM) signal capable of controlling the output of a DC/DC converter circuitry (for example, by controlling the pulse width of the PWM signal).

Light sensor 112 may comprise a photo-diode, photo-transistor (bipolar or MOS type), photo-cell, and/or a photo-resistance type of light sensor capable of generating a signal 203 indicative of or proportional to ambient light conditions.

In this embodiment, controller 202 may receive signal 203 and generate control signal 205 to adjust the brightness of the lamp based on ambient light conditions. Additionally or alternatively, controller 202 may be capable of generating signal 205 to adjust the contrast of the LCD panel 110 based on ambient light conditions. Thus, for example, if ambient light in the vicinity of the LCD panel 114 increases, controller 202 may generate control signal 205 to increase the brightness of the panel 114. Conversely, if ambient light in the vicinity of the LCD panel 114 decreases, controller 202 may generate control signal 205 to decrease the brightness of the panel 114. Thus, signal 203 may be used by controller 202 as a feedback signal.

The controller 202 may also be capable of receiving a preset value signal 207. Signal 207 may represent a preset LCD panel brightness value, as may be provided by a user of the camera 114. In this embodiment, controller 202 may be capable of receiving signal 203 as another feedback input. Signal 203 may operate as a command signal that sets a threshold level for the controller 202. Thus, for example, the preset value signal 207 may be used by the controller 202 to set a desired brightness value which, in turn, may cause controller 202 to override signal 203, or provide a threshold to limit a range of brightness variations, thus permitting a user to operate the panel display at a desired brightness level. Alternatively, and without departing from this embodiment, signal 207 may operate as a “ceiling” or “floor” value. In this instance, controller 202 may be capable of comparing signal 207 with signal 203 to ensure that the panel brightness does not exceed or fall below the brightness level indicated by signal 207, in addition to the comparison of signals 207 and 203 described above.

Preset value signal 207 may be generated by, for example, a variable resistor (e.g., user controlled potentiometer) located on the external housing of camera 114. Alternatively, user input circuitry may comprise a specified computer operation, which may include a selected button operations and/or menu selections. Such an implementation may include, for example, software and/or firmware instructions, executed by the camera. Alternatively, preset value signal 207 may be generated by preprogrammed and/or user programmable circuitry that is capable of generating a preprogrammed (or user programmable) preset value signal 207.

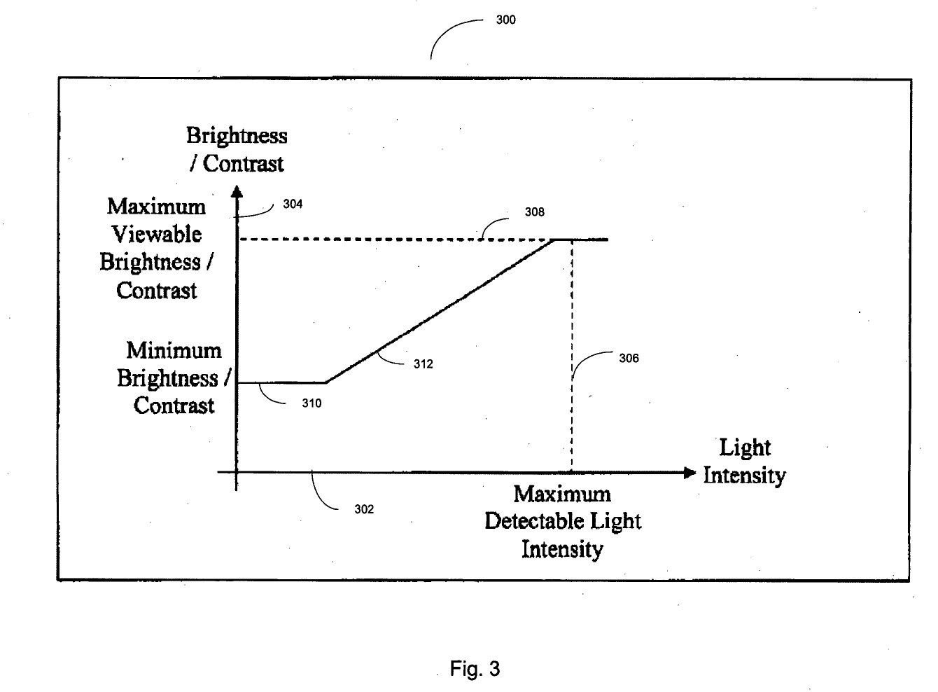

FIG. 3 depicts a graph 300 of exemplary operating characteristics according to one embodiment. In FIG. 3, the system 100 and 200 depicted in FIG. 1 and FIG. 2 have been omitted for clarity, but it is to be understood that the exemplary operating characteristics described with reference to FIG. 3 may be implemented in a manner consistent with an embodiment depicted in FIG. 1 and/or FIG. 2, or alternatively in other system implementations, without departing from this embodiment.

The x-axis 302 represents ambient light intensity and the y-axis 304 represents brightness and/or contrast of the LCD panel 114. In this embodiment, ambient sensor 112 may have a maximum detectible light intensity level, as may be represented by the substantially vertical line 306. Also, the LCD panel 114 may have a maximum viewable brightness and/or contrast level, as may be represented by an asymptote 308, and a minimum viewable brightness and/or contrast level, as may be represented by an asymptote 310. In operation, controller 202 may adjust the brightness/contrast of the LCD panel 114 based on the ambient light detected from sensor 112. This operation is depicted as a linear relationship 312 between levels 310 and 308. Of course, controller 202 may be capable of generating other relationships between ambient light levels and LCD panel brightness/contrast, for example, logarithmic, quadratic, and/or other non-linear relationships.

In this embodiment, if the ambient light level is equal to, or exceeds a maximum viewable brightness and/or contrast level 308, controller 202 may be capable of generating a control signal 205 to power down the LCD panel. Thus, battery power may be saved by powering off the LCD panel 110 under circumstances where the user could not view the LCD panel.

In alternative embodiments, and referring again to the system embodiment of FIG. 2, the digital camera 114 may also comprise an image sensor 210 (for example, a charge-coupled device (CCD) or CMOS device), capable of sensing the light characteristics of an image that may be captured by a lens (not shown) comprised in a digital camera. The image sensor 210 may be capable of generating a signal 211 indicative of an image captured by the lens. Controller 202 may be capable of displaying an image captured by the mage sensor 210 on the LCD display 110. Signal 211 may be indicative of the light characteristics of the light incident upon the camera lens. Controller 202 may be capable of receiving the signal indicative of the light characteristics of the light incident upon the lens, and may be further capable of using this signal as additional feedback information to control the brightness and/or contrast of the LCD panel. For example, if signal 211 indicates a bright image, controller 202 may be capable of adjusting the brightness and/or contrast of the LCD based at least in part on the value of signal 211.

Thus, in summary, at least one embodiment herein provides a brightness/contrast control system for an LCD panel display comprised in a digital camera. The system may include an LCD panel and an optical sensor generating a signal indicative of ambient light around the LCD panel. The system may also include a controller capable of generating at least one of a power and contrast control signal to control at least one of the brightness and contrast of the LCD panel based at least in part on the signal indicative of ambient light around the LCD panel. Advantageously, a digital camera according to at least one embodiment herein may be capable of using ambient light information to close the loop on the feedback information supplied to a controller. Additionally, a digital camera according to at least one embodiment herein may be capable of automatically adjusting the LCD panel brightness and/or contrast based on ambient light conditions. Advantageously, these features may permit the digital camera of these embodiments to exhibit enhanced versatility and utility compared to the prior art, and may reduce design costs and power requirements by employing the brightness and/or contrast control system described herein compared to the prior art. Further, although specific utility for the present disclosure has been described with reference to a digital camera, it is equally contemplated herein that the present disclosure may find utility in any hand-held or portable electronic device where brightness and/or contrast control of an LCD display may be desired.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

1. A brightness/contrast control system for an LCD panel display comprised in a digital camera, comprising:
an LCD panel;
an optical sensor generating a signal indicative of ambient light in the vicinity of said LCD panel; and
a controller capable of generating at least one of a power and contrast control signal to control at least one of the brightness and contrast of said LCD panel based at least in part on said signal indicative of ambient light in the vicinity of said LCD panel.

2. The system of claim 1, wherein:
said controller further capable of receiving a preset value signal indicative of at least one of a preset brightness and preset contrast of said LCD panel.

3. The system of claim 1, wherein:
said controller capable of controlling at least one of said brightness and said contrast based on a linear relationship between said ambient light and at least one of said LCD panel brightness and said LCD panel contrast.

4. The system of claim 1, wherein:
said digital camera is selected from a digital still camera and a digital video camera.

5. The system of claim 1, further comprising:
an image sensor capable of sensing the light characteristics of an image, said image sensor further capable of generating a signal indicative of the light characteristics of the sensed image, said controller further capable controlling at least one of the brightness and contrast of said LCD panel based at least in part on said signal indicative of the light characteristics of the sensed image.

6. The system of claim 1, wherein:
said controller is further capable of generating at least one of a power and contrast control signal to power off said LCD panel if said light in the vicinity of said LCD panel equals or exceeds at least one of a maximum viewable brightness and contrast level.

7. An apparatus, comprising,
a controller capable of controlling at least one of brightness and contrast of an LCD panel display comprised in a digital camera based at least in part on ambient light conditions in the vicinity of said LCD panel.

8. The apparatus of claim 7, wherein:
said controller further capable of receiving a preset value signal indicative of at least one of a preset brightness and preset contrast of said LCD panel.

9. The apparatus of claim 7, wherein:
said controller capable of controlling at least one of said brightness and said contrast based on a linear relationship between said ambient light and at least one of said LCD panel brightness and said LCD panel contrast.

10. The apparatus of claim 7, wherein:
said digital camera is selected from a digital still camera and a digital video camera.

11. The apparatus of claim 7, further comprising:
said controller further capable controlling at least one of the brightness and contrast of said LCD panel based at least in part on light characteristics of an image sensed by said digital camera.

12. The apparatus of claim 7, wherein:
said controller is further capable of controlling said LCD panel to power off said LCD panel if said light in the vicinity of said LCD panel equals or exceeds at least one of a maximum viewable brightness and contrast level.

13. A method, comprising:
generating a signal indicative of ambient light in the vicinity of an LCD panel comprised in a digital camera; and
controlling at least one of a brightness and contrast of said LCD panel based at least in part on said signal indicative of ambient light in the vicinity of an LCD panel.

14. The method of claim 13, wherein:
said controller further capable of controlling at least one of a brightness and contrast of said LCD panel based at least in part on a preset value signal indicative of at least one of a preset brightness and preset contrast of said LCD panel.

15. The method of claim 14, wherein:
said controller further capable of controlling at least one of a brightness and contrast of said LCD panel based at least in part on a on light characteristics of an image sensed by said digital camera.

16. The method of claim 13, further comprising:
controlling said LCD panel to power off said LCD panel if said light in the vicinity of said LCD panel equals or exceeds at least one of a maximum viewable brightness and contrast level.
